(19) United States
(12) Patent Application Publication
(10) Pub. No.: US 2011/0066746 A1
(43) Pub. Date: Mar. 17, 2011

(54) SYNCHRONIZED DATA STREAMING

(75) Inventors: JAMES D. BENNETT, HROZNETIN (CZ); JEYHAN KARAOGUZ, IRVINE, CA (US)

(73) Assignee: BROADCOM CORPORATION, IRVINE, CA (US)

(21) Appl. No.: 12/637,363

(22) Filed: Dec. 14, 2009

Related U.S. Application Data
(60) Provisional application No. 61/241,716, filed on Sep. 11, 2009.

(51) Int. Cl. G06F 15/16

(52) U.S. Cl. 709/231; 709/236

(57) ABSTRACT

A system and method in a media server for synchronizing media delivery sessions to a plurality of media players that are receiving the same media content. The method includes determining, for a group of the plurality of media players, to deliver streamed media in a synchronized manner through a multicast transmission based on at least one media player and network information. Once media transmission scheduling has occurred, the method includes modifying scheduling for outgoing content to change at least some content from unicast to multicast transmissions, or vice-versa based upon subsequently received media playback performance data and network performance data. Unicast and multicast content can be transmitted to a media player at the same time in one embodiment. Generally, scheduling is performed to avoid having a media player wait for content.

### CROSS-REFERENCE TO RELATED APPLICATIONS

The present U.S. Utility patent application claims priority pursuant to 35 U.S.C. §119(e) to U.S. Provisional Application Ser. No. 61/241,716, entitled “Synchronized Data Streaming,” (Attorney Docket No. BP20011), filed Sep. 11, 2009, pending, which is hereby incorporated herein by reference in its entirety and made part of the present U.S. Utility patent application for all purposes.

### BACKGROUND

1. Technical Field

The present invention relates to wired and wireless communications and, more particularly, to circuitry for synchronizing streaming data.

2. Related Art

In today's world of rapidly changing devices that instantly add features that become a significant part of everyday life, the Internet has served as a backbone for coupling networks of all types include cellular and wireless local area networks as well as wired networks. As different devices are developed to operate using these networks, popular features are often limited to the particular devices. Thus, devices are often application specific incompatible application related data formats and associated interfaces through they are operable to communicate over the various wireless and wired networks.

Many communication systems are known to support wireless and wire lined communications between wireless and/or wire lined communication devices, nonetheless, to support global communications. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards, including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, etc., communicates directly or indirectly with other wireless communication devices. For direct communications (also known as point-to-point communications), the participating wireless communication devices tune their receivers and transmitters to the same channel or channels (e.g., one of a plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via a public switch telephone network (PSTN), via the Internet, and/or via some other wide area network.

Each wireless communication device includes a built-in radio transceiver (i.e., receiver and transmitter) or is coupled to an associated radio transceiver (e.g., a station for in-home and/or in-building wireless communication networks, RF modem, etc.). The various circuit blocks of a radio transceiver jointly operate to support communications and associated functionality according to the type of communication system(s) it supports. It is desirable to improve efficiency of the communications through networks that support the various types of communication devices.

### SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered with the following drawings, in which:

FIG. 1 is a functional block diagram of a prior art network for delivering streaming media to a plurality of media devices.

FIG. 2 is a functional block diagram that illustrates a network according to one embodiment of the invention.

FIG. 3 is an example video frame according to one embodiment of the invention that supports multicast transmission to a plurality of media devices.

FIG. 4 is a network diagram that illustrates multicast and unicast transmitting compressed video frames of common streaming media content to a plurality of media players according to one embodiment of the invention.

FIG. 5 is a signal sequence diagram that illustrates operation according to one embodiment of the invention.

FIG. 6 is a functional block diagram of a media player received data queue according to one embodiment of the invention.

FIG. 7 is an alternate embodiment of a media player queue in which a media player does not know whether a frame is unicast or multicast transmitted.

FIG. 8 is a functional block diagram of media player received frame information according to one embodiment of the invention.

FIG. 9 is a functional block diagram of a network that unicast and multicast transmits streamed media over a plurality of different protocol communication networks according to one embodiment of the invention.

FIGS. 10 and 11 are flow charts that illustrate operation of the invention according to various aspects and embodiments.

FIG. 12 is a functional block diagram of an alternate embodiment of the present invention.

### DETAILED DESCRIPTION OF THE DRAWINGS

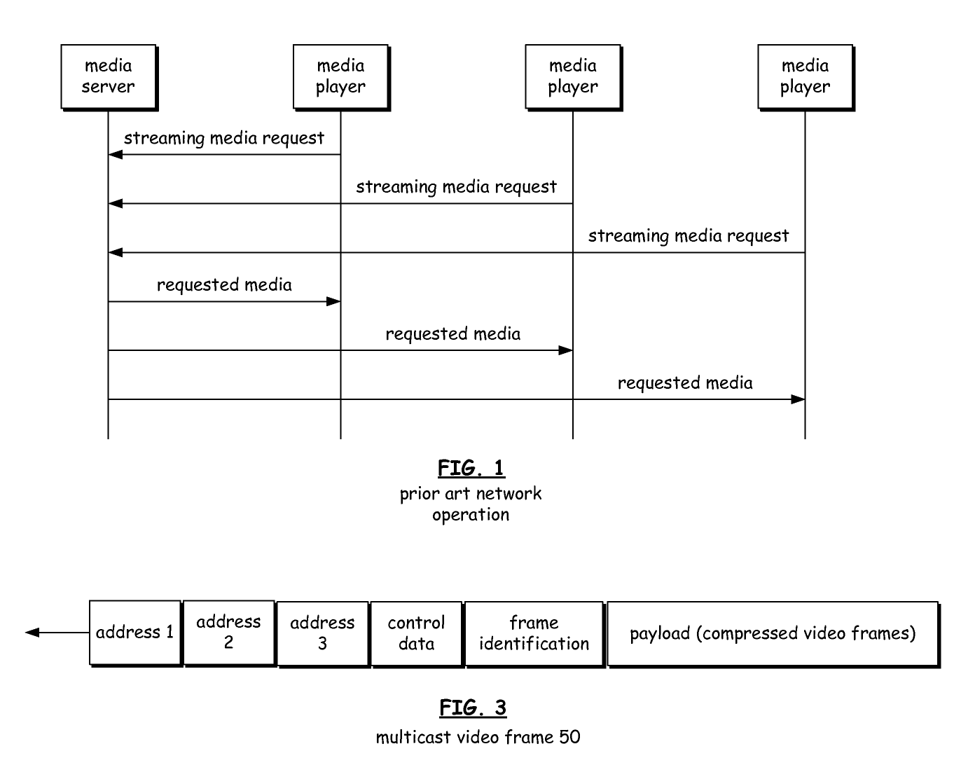

FIG. 1 is a functional block diagram of a prior art network for delivering streaming media to a plurality of media player devices (media players). In the prior art, a media server receives a plurality of streaming media requests (here, 3 requests) for the same streaming media within a specified period (e.g., 30 second). For example, all three requests might be for a broadcast sports show that just became available with updates on scores and sports stories. In response, the prior art media server or media server merely responds to each streaming media request and transmits the requested same streaming media to the requesting media players in an unsynchronized manner. Generally, a streamed media stream is sent from the media server in response to each streaming media request. In many cases, the communication pathways may be the same for portions of the pathway. The inventors have observed that such unsynchronized transmissions of streamed media can create loading for the media server that contains the source as well as communication pathway network elements, nodes, routers and equipment that may be reduced by synchronizing at least portions of the transmission of the requested streaming media.

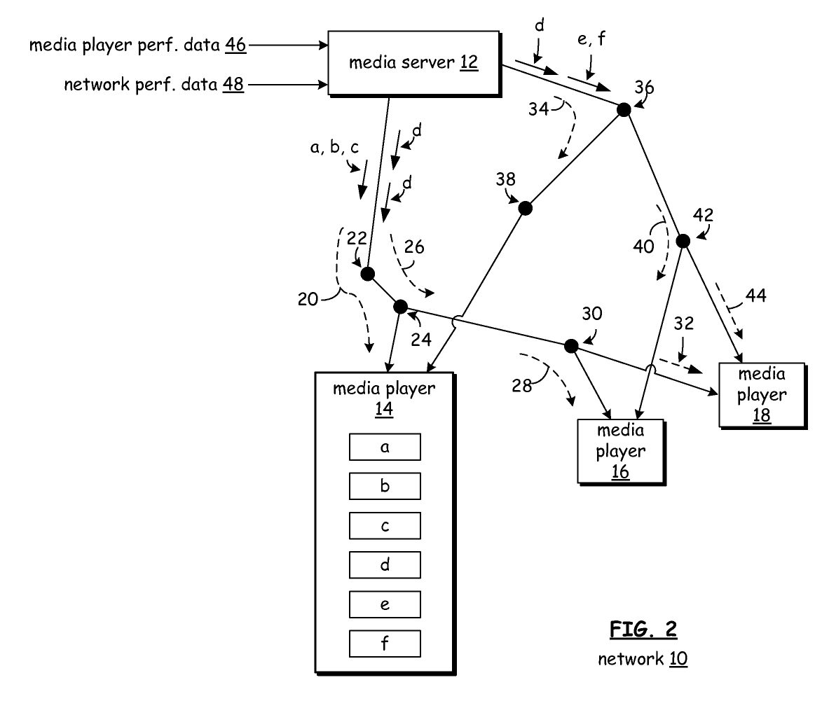

FIG. 2 is a functional block diagram that illustrates a network according to one embodiment of the invention. Network 10 includes a media server 12 that transmits streaming media to a plurality of devices within network 10 including media players 14, 16 and 18. The media players 14, 16 and 18 may comprise any device operable to receive streamed media over at least one of a plurality of communication networks. For example, a media player can comprise a dedicated Internet Protocol media player device that is coupled to a television to support playback of “On Demand” media content received by way of the Internet or other packet data network. A media player may also comprise a fixed location or portable handheld device include a cell phone, a “digital book”, a portable media player similar to DVD players, etc.

Generally, media server 12 transmits streaming media in a plurality of compressed video frames shown here in FIG. 1 as a, b, c, d, e and f through a plurality of network communication pathways that includes a plurality of network nodes. It should be understood that the network nodes may comprise any known type of packet data network node or any type of wired and wireless network element that routes, bridges and/or couples communication pathway portions to deliver a communication signal (in any form) to a subsequent communication pathway portion, node or element. The transmission of these compressed video frames as well as other types of data units are types are included in references herein to streamed media or streaming media for delivery of video content and other types of content that may be delivered or transmitted.

As may be seen, video frames a, b and c are transmitted in the example shown, in a synchronized manner:
to media player 14 along network communication pathway 20 through nodes 22 and 24;
to media player 16 along network communication pathways 26 and 28 through nodes 22, 24 and 30; and
to media player 18 along network communication pathways 26 and 32 through nodes 22, 24 and 30.

Similarly, video frames e and f are transmitted in the example shown, in a synchronized manner:
to media player 14 along network communication pathway 34 through nodes 36 and 38;
to media player 16 along network communication pathway 40 through nodes 36 and 42; and
to media player 18 along network communication pathway 44 through nodes 36 and 42.

Video frame d, on the other hand, is transmitted in an unsynchronized manner (individually) to media players 14, 16 and 18. Accordingly, as may be seen, video frame d is transmitted three times, once for each of the media devices.

Thus, to improve network efficiency, outgoing video streams of similar video content are synchronized so that one media stream can be delivered to a plurality of devices to improve transmission, network, and device operation efficiencies. Among other factors, media server 12 receives and evaluates media player and network performance data as a part of making decisions to synchronize transmissions to media players 14, 16 and 18. In one embodiment, media server 12 merely evaluates scheduled transmission parameters to determine whether to synchronize transmissions of media frames. In another embodiment, a media server may evaluate network performance and/or media player performance parameters to synchronize transmissions to improve efficiency. Generally, synchronizing transmissions comprises sending one media frame to a plurality of destinations in place of sending a plurality of frames, one to each destination. Accordingly, a number of transmitted frames may be reduced since a number of transmitted media frames may be replaced by a single media frame. Typically, in order to synchronize media frame transmissions, the transmission of one or more media frames may be delayed, stopped, buffered, etc., by the media server, so that the transmission timing of the media frames may be synchronized. Once such timing is synchronized for a plurality of similar media frames, the media server 12 is operable to transmit one frame in place of a plurality of frames to a plurality of destinations (e.g., media players).

In operation, media server 12 receives, within a specified duration, a plurality of media request messages for video content comprising streamed media for immediate delivery originated by a corresponding plurality of media players. Media server 12 also may also receive media player performance data 46 (generally, media player information) and/or network performance data 48 (generally, network information) and evaluates the media player and network information to determine network performance in relation to at least one network communication pathway (e.g., network communication pathways 20, 26, 28, 32, 34, 40 and 44).

In the described embodiment of the invention, media server 12 evaluates the network information to determine, for example, if a particular node such as node 36 is experiencing throughput delays due to heavy traffic, signal quality issues, and/or operational problems. When network performance data suggests that a network node is experiencing loading that exceeds one or more performance related thresholds, media server 12 may respond by evaluating whether any outgoing media streams of compressed video frames may be synchronized to reduce detected network loading for one or more communication pathways or nodes. Thus, if video frames d, e and f are scheduled for unsynchronized unicast transmission to each of media players 14-18, media server 12 may determine to synchronize the transmission of video frames e and f, as shown in FIG. 2, to improve network performance by reducing loading or congestion for one or more communication pathways or nodes.

Other types of network information may also be evaluated. For example, more static information such as communication pathway capability and/or communication standards may be evaluated. Thus, for example, multicast video frames may be transmitted over first network pathway according to a first communication standard while some unicast transmitted video frames may be transmitted over a second network pathway according to a second communication standard. These differing network pathways and associated communication standards may have differing performance characteristics that are evaluated for determining whether a frame should be transmitted in a synchronized or an unsynchronized manner.

Media server 12 receives media player performance data 46 for at least one of the plurality of media players 12, 14 and 16. Based on the media player information, media server 12 determines what portions of the streamed media that corresponds to the plurality of media requests should and can be multicast transmitted to the plurality of media players in a synchronized multicast transmission to reduce network congestion and loading as well as loading of media server 12. Accordingly, media server 12 determines, based on the network performance and the media player information, what portions of the streamed media should be unicast transmitted in non-synchronized unicast transmissions to each of the plurality of media players to avoid an interruption in playback of the streaming media by media players 14-16.

Here, in the example of FIG. 2, each of the video frames a-c and e-f are multicast transmitted in a synchronized manner while video frame d is unicast transmitted three times in an unsynchronized manner to each of the media players 14-18.

Typical media player performance data that media server 12 evaluates for each media player of media players 14-18 to determine what video frames should be unicast transmitted include queue size of buffered video data, a depletion rate of the queue, a loading rate of the queue, device playback ability, device status (paused, playing content, fast forwarding or rewinding content, etc.), device playback ability, gaps in received streamed media, and device or programming priority ratings (e.g., quality of service ratings for the device services or priority of the programming content). Moreover, in one embodiment, media server 12 further evaluates such media player performance data in relation to past performance or historical data to predict when a threshold might be reached which requires unicast transmissions to avoid playback interruption.

While FIG. 2 and other figures described herein may be described in terms of video frames, the concepts are generally applicable to any streamed media for a specified media content. More generally, determinations to unicast or multicast streamed media do not require that such determinations be made for discrete portions of the streamed media content.

FIG. 3 is an example video frame according to one embodiment of the invention that supports multicast transmission to a plurality of media devices. Here, the video frame includes layered IP addresses that define communication pathway, node or element addresses to which the video frame is to be transmitted. As each address location is reached, a network node or element (e.g., a data packet router) forwards video frame 50 to the next specified address. In one embodiment, the node of the address location that receives video frame 50 strips away the outermost address (which is its own address) and then forwards video frame 50 to the next address.

Video frame 50 includes a control data portion, a frame identification portion and a payload portion in one embodiment. The control data portion, for example, may include a bit field to indicate that a particular node is to forward video frame to a plurality of addresses or, alternatively, to all outgoing signal paths in a broadcast transmission. Generally, many different addressing schemes may be utilized wherein a video frame is transmitted to multiple destinations. For some applications, for example, any one of the nodes elements receiving the video frame may merely broadcast transmit the video frame along all outgoing paths.

In FIG. 2, for example, if node 42 is a data packet network router, node 42 may merely determine to forward a video frame received from node 36 along each outgoing pathway such as pathways 40 and 44. This determination may be based upon a specified indication in the bit field of the control data portion. Alternatively, if node 42 is a wireless access point, node 42 may broadcast transmit the received video frame thereby relying on the ability of media players 16 and 18 to identify, receive and process the broadcast transmission of the video frame. In such a case, the broadcast transmission is one that is not part of an established communication link with a single device.

In one embodiment, the received video frame includes an indication that specifies that the node should broadcast the video frame. In another embodiment, characteristics of address information may be used to determine that the nodes should broadcast the received video frame. Generally, any addressing protocol or scheme may be used that supports a video frame being transmitted only once by a video or media server such as media server 12 of FIG. 2 for delivery to a plurality of destinations (e.g., media players 14-18).

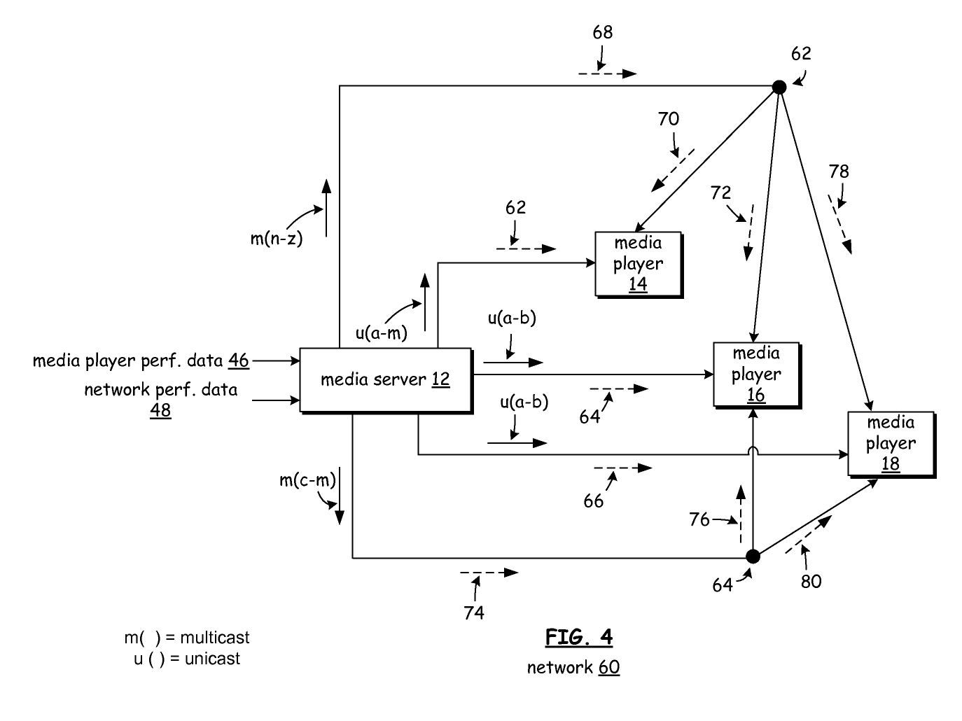

FIG. 4 is a network diagram that illustrates multicast and unicast transmitting compressed video frames of common streaming media content to a plurality of media players according to one embodiment of the invention. Generally, FIG. 4 illustrates that different groupings of multicast video frames may be used to deliver media content and that different media players (content destinations) may receive different frames through unicast transmissions. More specifically, media server 12, in FIG. 4, delivers unicast transmitted video frames to media players 14-18 by communication pathways 62-66, respectively. Media server 12 delivers multicast transmitted video frames to media player 14 by communication pathways 68 and 70, to media player 16 by communication pathways 68, 72-76, and to media player 18 by communication pathways 68, 78, 74 and 80.

More specifically, in response to receive media request messages for common (the same) media content from media players 14-18 within a specified period (e.g., 5 seconds), media server 12, determines to transmit the requested media content, which comprises compressed video frames a-z, in varying multicast and unicast transmissions based on internal logic. The internal logic determines to unicast and multicast transmit video frames based upon at least one of loading by media server 12, media player performance data 46 and network performance data 48. Thus, media server 12, in the exemplary operation of FIG. 4, determines to unicast transmit frames a-m to media player 14, and to unicast transmit frames a and b to media players 16 and 18. Media server 12 further determines to multicast transmit frames n-z to all three media players and to multicast transmit frames c-m to media players 16 and 18. The notation of FIG. 4 of u(a-m), for example, refers to frames a-m being unicast transmitted. Similarly, u(a-b) refers to frames a-b being multicast transmitted.

Thus, the transmission of all 26 frames a-z to media players 14-16 are as follows:
frames a-m are unicast transmitted to media player 14 by communication pathway 62;
frames a-b are unicast transmitted to media player 16 by communication pathway 64;
frames a-b are unicast transmitted to media player 18 by communication pathway 66;
frames c-m are multicast transmitted to media player 16 by communication pathways 74 and 76;
frames c-m are multicast transmitted to media player 18 by communication pathways 74 and 80;
frames n-z are multicast transmitted to media player 14 by communication pathways 68 and 70;
frames n-z are multicast transmitted to media player 16 by communication pathways 68 and 72; and
frames n-z are multicast transmitted to media player 18 by communication pathways 68 and 78.

In operation, several alternatives exist for achieving these multicast transmissions that share a common pathway for a portion of the total communication pathway. In one embodiment, addressing and control signaling are used to control multicast transmitting frames to a plurality of destinations. For example, the multicast transmission of frames n-z shares communication pathway 68 only. Node 62 then forwards multicast frames n-z along each of communication pathways 70, 72 and 78 to media players 14, 16, and 18, respectively, based control signaling or an addressing scheme that instructs node 62 to perform such forwarding.

In an alternate embodiment, multicast transmitted frames are transmitted by media server 12 with an indication that node 62 is to broadcast transmit the multicast frames. Thus, if node 62 is a router, the received broadcast indication prompts node 62 to forward each of the multicast frames along each outgoing communication pathway. Here, the outgoing communication pathways are communication pathways 70, 72 and 80. If node 62 includes wireless transceiver circuitry, the received broadcast indication prompts node 62 to wirelessly transmit multicast frames n-z as a broadcast transmission for reception and processing by media players 14-18. The broadcast indication may be an explicit command indicated by a control signal or control data (a bit, word, etc.) or an implicit command that may be inferred by node 62 according to a communication protocol. For example, if node 62 receives multicast transmitted frames n-z without an associated deliver address, node 62 can infer that it is to broadcast transmit video frames n-z.

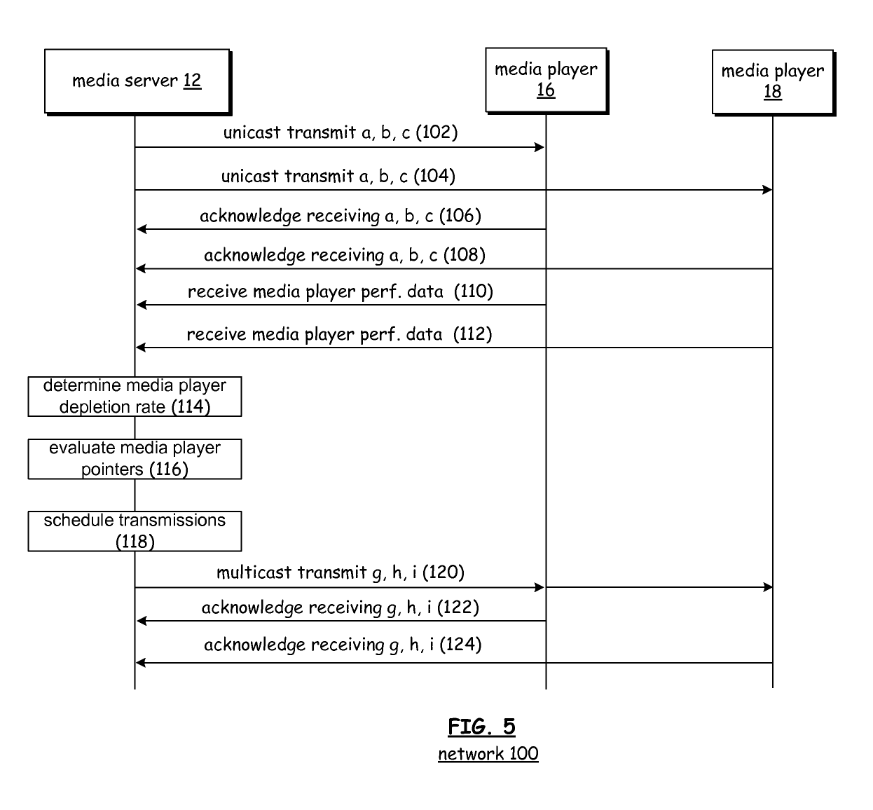

FIG. 5 is a signal sequence diagram that illustrates operation according to one embodiment of the invention. A media server 12 unicast transmits frames a, b, c to media player 16 (102) and to media player 18 (104) and receives acknowledgment for each of a, b, c (106) and (108), respectively. The acknowledgments (106) and (108) may be according to any knows form for acknowledgment including acknowledge (ACK), negative-acknowledge (N-ACK). Moreover, the acknowledgements may be on a frame-by-frame, data unit by data unit, or block basis (for a plurality of frames or data units). Media server 12 also receives media player performance data from media player 16 (110) and from media player 18 (112). The media player performance data is similar to media player performance data 46 described previously.

In one embodiment of the invention, because each media player 16 and 18 transmits media player status information (110) and (112) to media server 12, status information is transmitted in place of acknowledgments. The status information in (110) and (112) allows media server 12 to determine what frames (or data units) were successfully received.

Based on the received media player 16 and media player 18 status information, media server 12, for each of media player 16 and media player 18, determines a media player depletion rate (114), evaluates media player pointers for unicast and multicast transmitted frames (116) and schedules subsequent transmissions (118). Scheduling transmissions in (116) includes the steps of determining what frames should be unicast transmitted and what frames should be multicast transmitted to each of media player 16 and media player 18.

In the example of FIG. 5, media server 12 subsequently multicast transmits frames g, h, i (120) to media player 16 and media player 18. Thereafter, media server 12 receives acknowledgements (122) and (124) from media player 16 and media player 18 for frames g, h, i. As described before, such acknowledgements may be in any form including merely within media player performance data messages that are subsequently received.

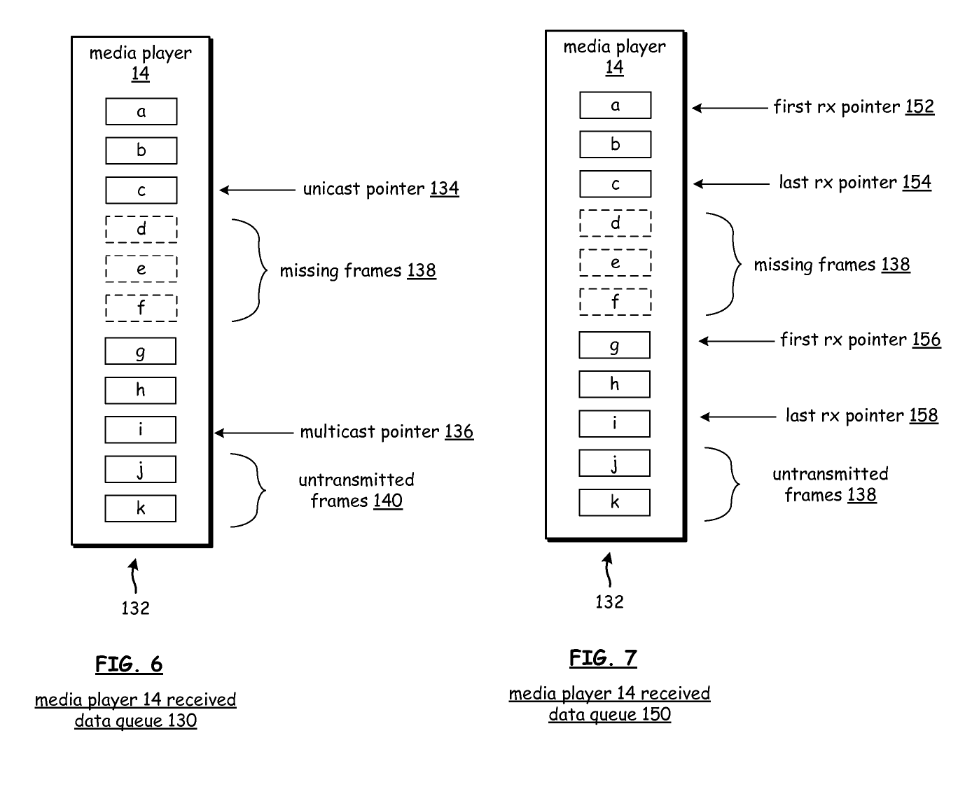

FIG. 6 is a functional block diagram of a media player received data queue according to one embodiment of the invention. A media player 14 data queue 100 includes a queue for received and unprocessed video frames received from a media server. Queue 130 comprises a buffer or memory that is used for storing the received video frames whether received that were unicast transmitted and/or multicast transmitted from a media server (e.g., media server 12). In the example of FIG. 6, frames a-c were unicast transmitted while frames g, h, i were multicast transmitted. In the example of FIG. 6, frames a-k are to be transmitted in total to media player 14 as shown generally at 132. Unicast pointer 134, therefore, indicates a register or memory address or other indication of the last received unicast frame. Similarly, multicast pointer 136 indicates a register or memory address or other indication of the last received multicast frame. As such, at least one of media player 14 and media server 12 is operable to determine missing frames 138 and frames that have yet to be transmitted shown as untransmitted frames 140. In this embodiment, media player 14 is able to determine whether a received frame was unicast or multicast transmitted by evaluating transmission data (transmission addresses) or a bit field that indicates whether a frame is being unicast or multicast transmitted.

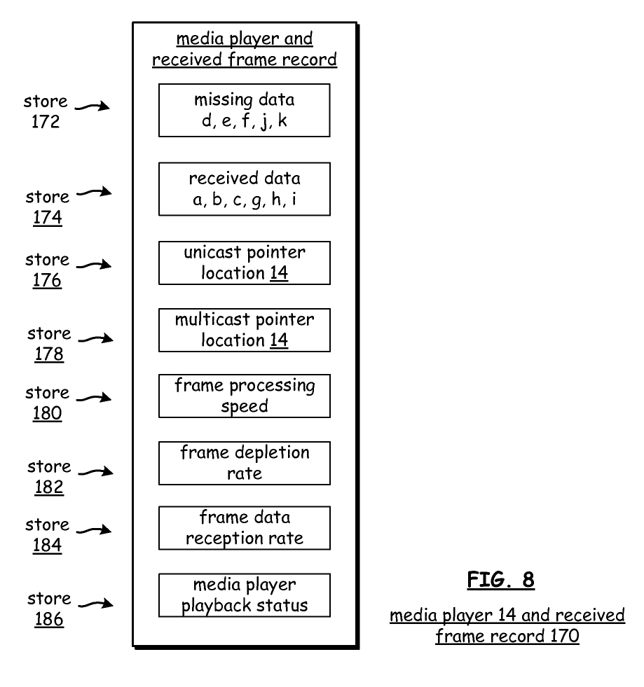

FIG. 7 is an alternate embodiment of a media player queue in which a media player does not know whether a frame is unicast or multicast transmitted. Here, media player 14 received data queue 150 includes a plurality of pointers that are used to monitor what frames have been received. Specifically, a first rx pointer 152 indicates a first register or memory address or other indication of a first received frame that does not follow a prior received frame. A last rx pointer 154 indicates a last register or memory address or other indication of a last received sequential frame that follows a prior received frame. For example, frame a is a first frame of a specified streamed media. Frame a does not follow any frames of a series of related frames that form a media content. Frame c, on the other hand, follows frame b. Similarly, a first rx pointer 156 indicates a first register or memory address or other indication of a first received frame that does not follow a prior received frame. Here, pointer 156 points at g and is a first rx pointer since a gap exists following frame c. A last rx pointer 158 indicates a last register or memory address or other indication of a last received sequential frame that follows a prior received frame. Here, pointer 158 points at frame i which follows received frame h. Based on these pointers, missing frames 138 and untransmitted frames 140 may be determined regardless of whether frames were unicast or multicast transmitted.

Referring to both FIGS. 6 and 7, the queue of received frames 132 (or alternatively, received and unprocessed frames 132), the information generally reflects information that media server 12 requires to determine whether to unicast or multicast transmit frames to a media player such as media player 14. In one embodiment, therefore, a media player such as media player 14 utilizes such pointers as a part of determining its status regarding received frames. In another embodiment, however, media player 14 merely tracks received frames and forwards such information to media server 12 which then, based on what it knows about its unicast transmissions of a. b, c and its multicast transmissions of g, h, i, can determine what frames require transmission and a priority for the frame transmissions.

FIG. 8 is a functional block diagram of media player received frame information according to one embodiment of the invention. A media player 14 received frame record 170 includes a plurality of stores that track the received media frame information. In general, a plurality of processing factors may be evaluated by one or both of a media player and a media server as a part of making multicast and unicast transmission determinations. Such processing factors include, in one embodiment, a media player performance, an amount of unprocessed streamed media, a playback location, a media player unprocessed streamed media depletion rate, a media player processing speed, a streamed media reception rate, a media player queue status that contains unprocessed streamed media, a media player playback status, a media player video reception rate, and a media player reception capacity. These processing factors may be values that are calculated by a media player or media server or they may be related to rates of change of various data parameters.

In one embodiment, for example, a media player store 172 tracks missing frames d, e, f, j, and k. A store 174 tracks received frames a, b, c, g, h, i. A store 176 tracks at least one unicast pointer location for media player 14 while a store 178 tracks at least one multicast pointer location for media player 14. A store 180 stores a determined a frame processing speed. A frame depletion rate is stored in store 182. A determined frame or data reception rate is stored in store 184 while a media player play back status is stored in store 186. The frame depletion rate, for example, can be an indication of the growth (or reduction) rate of a queue or buffer containing unprocessed streamed media (e.g., video frames). A media player playback status can be any play back status information such as whether playback has been paused, whether playback is being “re-winded” to playback previously played media content or “fast forwarded” to content that is beyond the most recently played content, etc. Thus, many different processing factors may be used, including factors not listed here, for determining whether to multicast or unicast media frames or to multicast and unicast transmit media frames to one or more media players.

Some of the information of record 170 may be information that is determined by media server 12 or by media player 14 while the other of media server 12 and media player 14 determines the remaining information. Alternatively, all of the information of record 170 may be determine solely be one of media server 12 and media player 14. Any or all of the information as well as other frame and media player 14 information determined by media player 14 may be transmitted to media server 12 as a part of the media player information that is transmitted to media server 12. Generally, transmission scheduling by media server 12 is based at least partly on some or all of the information of record 170.

For example, based on pointer locations, media server 12 may be able to determine a depletion rate. Thus, media server 12 evaluates the determined depletion rate to determine whether one or more frames needs to be unicast transmitted to make sure that media player 14 does not wait for a specified frame. Such a unicast frame may be, for example, transmitted in addition to other multicast transmitted frames being transmitted to media player 14. Alternatively, media player 14 may determine the depletion rate and transmit the depletion rate to media server 12 to use for such scheduling determinations.

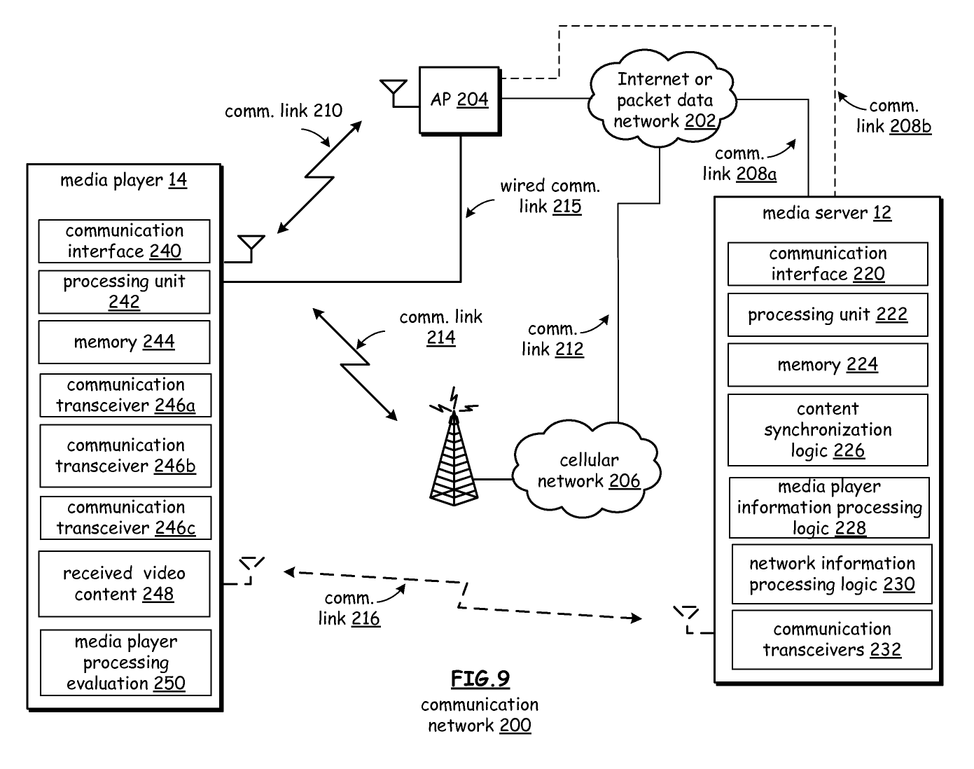

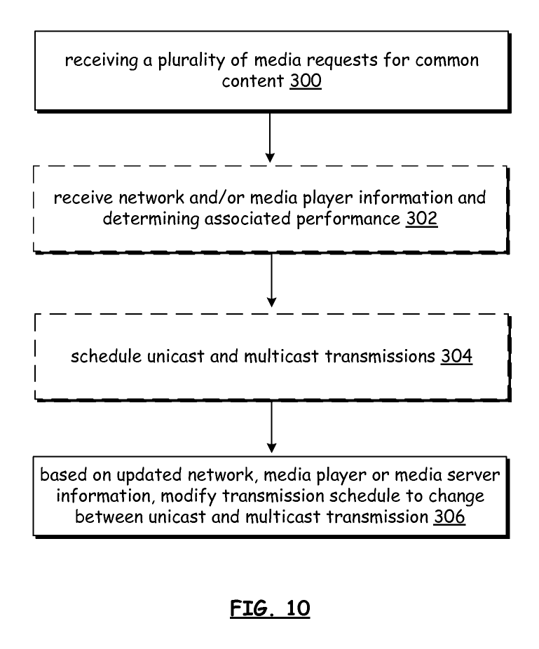

FIG. 9 is a functional block diagram of a network that unicast and multicast transmits streamed media over a plurality of different protocol communication networks according to one embodiment of the invention. A network 200 includes media server 12 and media player 14 as well as a plurality of communication networks and elements to support communications between media server 12 and media player 14. An Internet or packet data network (herein, packet data network) 202, supports communicative coupling to access point 204 and to cellular network 206 to establish a communication pathway between media server 12 and media player 14. Packet data network 202 includes wide area networks and local area networks.

A first communication pathway comprises packet data network 202, access point 204 and communication links 208a and 210. Communication link 208a includes network elements to establish a communication link with packet data network 202 such as broadband modems and gateway devices that, in association with a broadband service, create Internet connections for users. Similarly, AP 204 which is in proximity with media player 14, may be connected to packet data network 202 by broadband modems, gateway devices and/or other communication elements. In the example of FIG. 9, communication link 210 comprises an IEEE 802.11 based wireless local area network communication link to support wireless communications with media player 14. Wireless communication link 210 may be replaced by a wired communication link 215 (e.g., a Ethernet based communication link). Alternatively, media server 12 may communicate directly with AP 204 to establishing communication link 216.

A second communication pathway comprises packet data network 202, as described above, as well as cellular network 206 and communication links 212 and 214. Cellular network 206 comprises cellular network elements according to any known cellular communication standard for voice and/or data communications. While communication link 210 is, in the described embodiment, a WLAN communication link according IEEE 802.11 standards, communication link 214 is according to a cellular standard.

Finally, a third communication pathway comprising a peer-to-peer communication link 216 may be established for delivery of streamed media. Here, communication link 216 may be a wireless proximity based communication link according to Bluetooth, IEEE 802.11 or other wireless communication standards or protocols or, alternatively, a wired or tethered communication link.

As may be seen, media server 12 comprises a communication interface 220 to format communication signals according to an ingoing or outgoing signal format. A processing unit 222, in conjunction with a memory 224, transmits outgoing and receives ingoing communication signals via communication interface 220. Media server 12 further includes content synchronization logic 226 that schedules outgoing data frames for unicast transmitting video frames in an unsynchronized manner and for multicast transmitting video frames in a synchronized manner based on determinations made by media player processing logic 228 and network information processing logic 230. Logic 228 evaluates media player 14 status and performance to determine whether to unicast or multicast transmit one or more frames as discussed above. Logic 230 evaluates network performance data such as network performance data 248 to determine if network conditions indicate levels of congestion in certain portions, pathways, or network elements that should be improved by reducing network traffic through the network portion, pathway or elements. Content synchronization logic also evaluates loading of media server 12 to determine if synchronizing transmissions could reduce its loading or improve its performance. Finally, media server 12 includes communication transceivers 232 that support communications according to the various protocols.

Media player 14 also includes a communication interface 240, a processing unit 242 and memory 244, and communication transceivers 246a-c that operate similarly to outgoing and ingoing communications. While media server 12 is shown with communication transceivers 232, media player 14 is shown with three communication transceivers 246a-246c. For each device, a plurality of communication transceivers may be included to support expected communications. Media player 14, for example, may including a Bluetooth transceiver to support communications over communication links 210 and 216, an 802.11 based WLAN transceiver for communications over communication link 210, and a cellular transceiver to support cellular communications over communication link 214. Moreover, one or more of these transceivers may include a plurality of transmitter and receiver front ends to support communication links over a plurality of communication channels so support multi-channel communications such as those for multiple in multiple out (MIMO) communications.

Media player 14 further includes a store 248 for storing or buffering received streamed media. The streamed media stored therein may be all of the received streamed media for a specified media content delivered to media player 14 as streamed media or received and unprocessed streamed media. Thus, prior references to queue size for received frames would comprise all of the content relating to specified media content if store 248 only keeps unprocessed streamed media. Alternatively, if store 248 includes all content (processed and unprocessed) for a specified streamed media, then references to queue size refer to unprocessed streamed media for a specified streamed media stored within store 248.

Finally, media player 14 includes a media player processing evaluation module 250 that determines one or more operational characteristics of media player 14 that may be transmitted by media server 12 in association with streamed media and/or media player operations. Thus, for example, module 250 may track media player 14 playback status operational modes (e.g., stopped, rewinding, etc.) and may send such mode information to media server 12. Module 12 may also, according to embodiment, determine one or more of queue, depletion rate, media player 14 processing rate, media player 14 streamed media reception rate, media player reception status, size or amount of unprocessed content, media player 14 reception capacity, acknowledge, signal communication error rates and other communication link characteristics.

In operation, media server 12 may establish a media delivery session that includes one or more communication pathways. In an embodiment in which multiple communication pathways are used to deliver streamed media, the pathways may be according to different communication standards or protocols. In relation to transmission scheduling, for example, unicast transmitted frames may be transmitted over a different communication pathway and associated communication protocols that multicast transmitted frames.

For example, media server 12 may multicast transmit frames g, h, i as described before by way of packet data network 202 (and therefore through common routers and network elements for delivery to media player 14 via communication link 210 using WLAN communication protocols and associated communication transceiver 246a, 246b or 246c. While such communications occur and media server 12 is multicast transmitting frames g, h, 1 to media player 14, media server 12 may also unicast transmit video frames through another communication protocol at the same time or at a different time. For example, media server 12 may use a communication pathway such as the pathway that includes cellular network 206 and communication links 212 and 214.

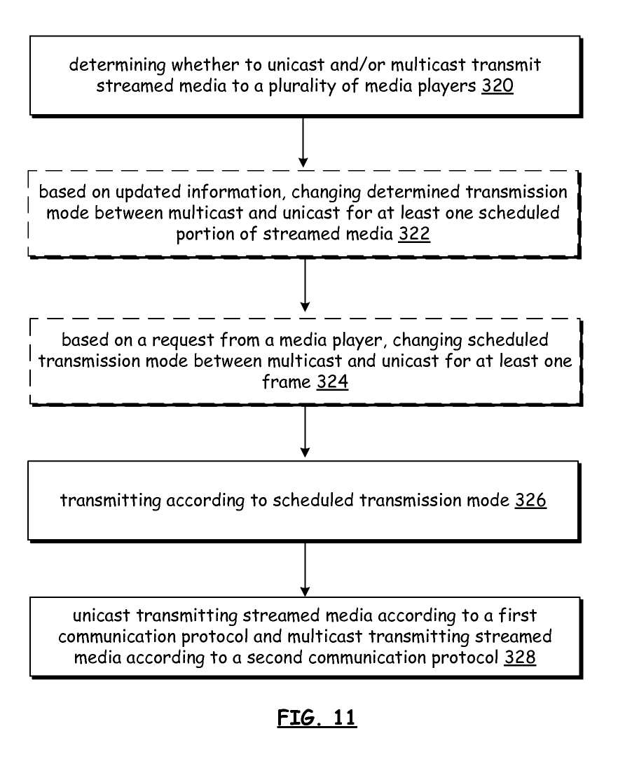

FIGS. 10 and 11 are flow charts that illustrate operation of the invention according to various aspects and embodiments. Referring to FIG. 10, a method is shown for a media server, e.g., media server 12, which includes receiving, within a specified duration, a plurality of media request messages for streamed media for immediate delivery originated by a corresponding plurality of media players (300). The method further includes receiving network information and determining network performance in relation to at least one network communication pathway and receiving media player information for each of the plurality of media players and determining media player performance (302). Determining media player performance can be nothing more than receiving and storing performance characteristics or, alternatively, receiving data (including raw performance data) which, for example, media server 12 then evaluates to determine performance.

In one embodiment, a media server determines to synchronize transmissions of media frames and to multicast transmit the media frames based on whether similar media frames are scheduled for unicast transmission within a specified window in which it is possible to delay transmissions to one or more media players to synchronize the transmissions. In another embodiment in which network and or media player information is received, the method includes, based on at least one of the network information and the media player information, determining what portions of the streamed media that corresponds to the plurality of media requests should be multicast transmitted to the plurality of media players in a synchronized multicast transmission and what portions of the streamed media should be unicast transmitted in non-synchronized unicast transmissions to each of the plurality of media players (304). The scheduling of such transmissions may also be based on performance data of the media server itself such as detected loading of the media server as well as the network and media player information including the processing factors and other similar factors discussed above.

When determining to synchronize transmissions of certain frames, a media server may determine to synchronize outgoing frames or streamed media for media players that are very close in terms of what portion of a streamed media or frame is being played. In an example where media player queue pointers are known, transmissions may be synchronized for media players having a pointer that indicates common playback location of the streamed media or common queue size. A media server may also synchronize transmissions based on common depletion rates or processing rates of media content or even common required data resolution or expected quality of service.

Finally, based on updated network, media player or media server information, modify the transmission schedule to change between unicast and multicast transmission 306 for at least one portion of streamed media (e.g., at least one frame).

Previously scheduled unicast transmissions may be changed to be multicast transmissions to reduce increased loading of a device or portion of a communication pathway to improve network transmission delay. Alternatively, based on a data reception rate in relation to a depletion rate, a media server may determine to reschedule certain frames from multicast to unicast and to transmit such frames immediately. These unicast frames may then be transmitted at different times or concurrently with the transmission of multicast frames. A media server may also reschedule unicast frames as multicast frames based on media player playback mode. This would allow the media player to receive multicast frames while playback is paused to reduce transmissions by a media server such as media server 12 and to improve network loading and performance. Generally, updated information that corresponds to the factors used to originally schedule video frame transmissions as unicast or multicast transmissions may be used to reschedule a video frame from multicast to unicast transmission or vice-versa.

Referring to FIG. 11, the method includes determining whether to unicast and/or multicast transmit video frames to a plurality of media players (320). Thereafter, based on updated information, changing determined transmission mode between multicast and unicast for at least one frame (322) or portion of streamed media. Also, based on a request received from a media player, changing determined transmission mode between multicast and unicast for at least one frame (324). The method also includes transmitting according to the determined transmission mode (326) as most recently determined. Finally, in one embodiment, the method includes unicast transmitting video frames according to a first communication protocol and multicast transmitting video frames according to a second communication protocol (328). Such operation may be, for example, as previously discussed in relation to FIG. 9.

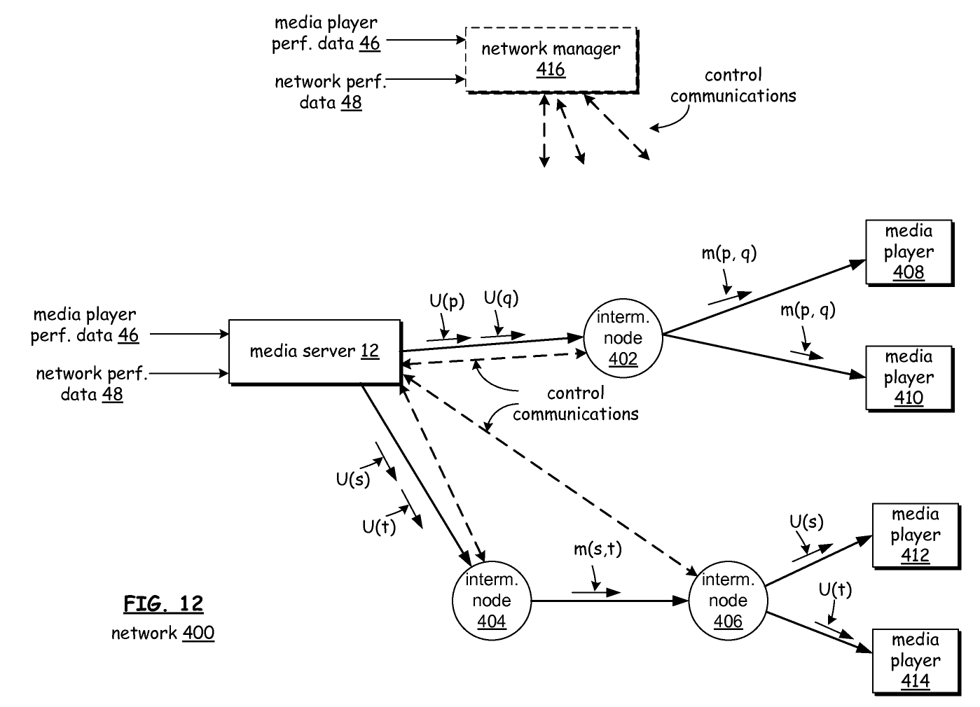

FIG. 12 illustrates an embodiment of the invention in which transmitted unicast frames are synchronized and transmitted as multicast frames by an intermediary node. Generally, multicast transmissions are discussed in relation to a server determining to generate multicast transmissions in place of a plurality of unicast transmissions. It is within the scope of the embodiments of the present invention, however, for a downstream intermediary node to receive a plurality of unicast transmissions and to multicast transmit the received unicast frames. The intermediary node may multicast transmit frames to an end destination or merely to another intermediary node. To illustrate, multicasting may be performed only for transmissions between intermediary nodes to save network resources wherein the multicast frames are subsequently separated into a plurality of unicast frames to the final destinations or they may be synchronized and transmitted as multicast frames to end final destinations.

Further, a determination for an intermediary node to multicast frames received as unicast frames may be made either by the intermediary node or by the content server (e.g., server 12) or by a network manager. In the case where server 12 makes such determinations, a control communication occurs between server 12 and one or more intermediary nodes to effectuate the synchronization of unicast frames.

For such and other reasons, therefore, a frame with addressing formats similar to that of FIG. 3 may be used to ensure that frames are routed to the intermediary node that is to synchronize unicast (unsynchronized) frames. Alternatively, known encapsulation techniques may be used to cause a frame to be routed through a desired intermediary node to support downstream multicasting by the desired intermediary node. The final destination address is therefore encapsulated for use by a downstream intermediary node to deliver the frame to the desired endpoint.

Referring now to FIG. 12, media server 12 transmits video frames to intermediary nodes 402 and 404 for delivery one or more of media players 408-414. As may be seen, frames that are transmitted to mode 404 are delivered to media players 412 and/or 414 by way of one or more additional intermediary nodes. Here, frames transmitted by node 404 are transmitted to intermediary node 406 prior to delivery to one or more of media players 412 and 414.

Specifically, media server 12 transmits unicast frames p and q to intermediary node 402 and frames s and t to intermediary node 404. Frames p and q are the same and frames s and t are the same. Node 402 synchronizes frames p and q to multicast transmit the video frame to media players 408 and 410. In FIG. 12, this multicast frame is shown as m(p,q) to reflect that one multicast frame is being transmitted in place of the two unicast frames p and q. Similarly, intermediary node 404 synchronizes frames s and t to transmit multicast frame m(s,t) to intermediary node 406. Intermediary node 406 then transmits two unicast frames shown as u(s) and u(t) to media players 412 and 414, respectively. As may be seen, transmissions between nodes 404 and 406 are synchronized to improve network efficiency before being separated for delivery to the destination media players as unsynchronized unicast frames (as they were originally transmitted by media server 12).

One aspect of the embodiment of FIG. 12 is that media server 12 engages in control communications to intermediary nodes 402, 404 and 406 to support the synchronization of unicast frames for transmission as a multicast frame or to support the transmission of unicast frames from a received multicast frame. Such control communications can include commands to buffer, stop or delay the transmission of received frames or to specify routing and or delivery information. In relation to FIG. 12, for example, server 12 may engage in control communications with node 404 to specify that frames should be buffered and then multicast transmitted and/or to specify that the multicast frames should be transmitted to node 406. Server 12 may also engage in control communications with node 406 to specify destination addresses of media players 412 and 414 for received multicast frames and whether a received multicast frame should be separated into a plurality of unicast frames.

Another aspect of the embodiment of FIG. 12 is that a network manager 416 may engage with intermediary nodes 402-406 and media servers 12 to control synchronization and delivery of video frames in a similar manner to improve network efficiencies. Logic for synchronizing frames is as described in relation to the media servers and or media players of the previous figures. Network manager 416 is operable to receive media player performance data 46 and/or network performance data 48 similar to media server 12.

For each of these embodiments, media server 12 may communicate with intermediate network nodes or elements to synchronize and multicast frames sent to it in a unicast fashion to specify how much to delay, buffer, etc., video frames to support downstream multicasting. Additionally, server 12 or a network manager 416 (or other device) may communicate with the intermediary nodes to specify destinations for multicast frames that are to be transmitted to subsequent destinations as unicast frames or as multicast frames.

In the various embodiments of the invention, a device makes a determination that streamed media should be multicast transmitted based on certain media player information for a plurality of media players being similar or substantially similar. For example, a reference to substantially similar pointers may be made in the specification or the claims. Generally, one of average skill in the art, will specify logic for the device that includes a judgment that such parameters have values that are similar enough to support a determination that streamed media should be multicast transmitted. For example, if media player information for two media players suggests that playback of the streamed media is within a specified range (e.g., 3 seconds), as indicated by queue pointers or other indications, the device may decides to at least some streamed media may be multicast transmitted. Thus, terms such as “similar” or “substantially similar” reflect a judgment that to values are equal within a specified range of values or tolerances. Hardware logic and circuitry of the various embodiments of the invention may include logic to perform the method steps described herein.

As one of ordinary skill in the art will appreciate, therefore, the term “substantially” or “approximately”, as may be used herein, provides an industry-accepted tolerance to its corresponding term and/or relativity between items which may be subject to design judgment. Such an industry-accepted tolerance ranges from less than one percent to twenty percent and corresponds to, but is not limited to, component values, integrated circuit process variations, temperature variations, rise and fall times, and/or thermal noise, and measurements of quantity or time. Such relativity between such items ranges from a difference of a few percent to magnitude differences.

As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Moreover, the term “operable to” requires a device to include logic, circuitry, or computer instructions stored in memory or other structure that facilitates the functionality associated with such language. As one of ordinary skill in the art will also appreciate, inferred coupling (i.e., where one element is coupled to another element by inference) includes direct and indirect coupling between two elements in the same manner as “operably coupled”.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but, on the contrary, the invention is to cover all modifications, equivalents and alternatives falling within the spirit and scope of the present invention as defined by the claims. As may be seen, the described embodiments may be modified in many different ways without departing from the scope or teachings of the invention.

1. A method in a media server, comprising:
receiving a plurality of media request messages for streamed media for immediate delivery originated by a corresponding plurality of media players;
evaluating a plurality of outgoing media frames and determining to delay at least one outgoing media frame to synchronize transmissions for at least two of the outgoing media frames for at least two of the plurality of media players; and
synchronizing the media frame transmissions for at least two of the plurality of media players and reducing a number of outgoing transmission frames to be less than a number of received media request messages and corresponding plurality of media players.

2. The method of claim 1 further including:
receiving at least one of network information that indicates network performance in relation to a network communication pathway and media player information for at least one of the plurality of media players indicating media player performance; and
based on at least one of the received network information and the received media player information, determining what portions of the streamed media that corresponds to the plurality of media request messages should be multicast transmitted in at least one synchronized multicast transmission and what portions of the streamed media should be unicast transmitted in at least one non-synchronized unicast transmission to one or more media players of the plurality of media players.

3. The method of claim 1 further including receiving updated media player information for a media player and determining what portions of the streamed media scheduled for multicast transmission should be unicast transmitted so that the media player does not have to wait to receive streamed media for processing.

4. The method of claim 1 further including evaluating at least one processing factor as a part of determining whether to multicast transmit a streamed media frame in a synchronized transmission, the at least one processing factor comprising at least one of:
a media player performance;
a amount of unprocessed streamed media;
a playback location;
a media player unprocessed streamed media depletion rate;
a media player processing speed;
a streamed media reception rate;
a media player queue status that contains unprocessed streamed media;
a media player playback status;
a media player video reception rate; and
a media player reception capacity.

5. The method of claim 4 further including, determining to unicast transmit at least one media frame based on at least one of the evaluated processing factors to a media player that is receiving multicast transmitted media frames.

6. The method of claim 5 further including determining to unicast transmit streamed media while also multicast transmitting streamed media to at least one media player based on at least one of media player information and communication pathway media delivery capacity.

7. The method of claim 4 further including determining to multicast transmit streamed media to the media player based on determining that the media player has paused playback of streamed media.

8. The method of claim 2 further including, for the plurality of the media players, synchronizing transmissions for at least a portion of the streamed media based an updated indication of at least one of media player queue status, media player playback status, media player video reception status, media player processing speed, and media player processing capacity that are substantially similar.

9. The method of claim 2 further including, for a plurality of the media players, synchronizing transmissions according to a depletion rate of a queue of at least one media player.

10. The method of claim 2 further including, for a single media player, determining what portions of streamed media should be unicast transmitted in an unsynchronized manner and what portions should be multicast transmitted in a synchronized manner.

11. The method of claim 2 further including, for an identified network communication pathway, synchronizing transmissions to reduce network communication pathway traffic and congestion.

12. The method of claim 2 further including determining to multicast transmit streamed media to a plurality of media players based on the plurality of media players having at least one of a similar streamed media queue depletion rate, a similar communication pathway traffic rate, a similar media player playback rate, or a common communication pathway signal path or node.

13. The method of claim 2 further including determining to multicast transmit streamed media to the media player through a first communication network and a first corresponding communication protocol and to unicast transmit streamed media to the media player through a second communication network and a second corresponding communication protocol.

14. A method in a media server, comprising:
scheduling unicast streamed media to a plurality of media devices;
delaying at least one scheduled unicast streamed media transmission and synchronizing at least two scheduled transmissions;
multicast transmitting streamed media in a synchronized manner to the plurality of media devices;
receiving at least one of network information and media player information for a media player of the plurality of media players; and
based on at least one of the network information and the media player information, determining to deliver a portion of the streamed media scheduled for multicast transmission to the media player in an unsynchronized manner in a unicast transmission.

15. The method of claim 14 further including evaluating, for the media player, at least one of a depletion rate of received and unprocessed streamed media, video reception status, a media player processing speed, and a media player capacity to change between unicast and multicast transmitting a media frame to the media player.

16. The method of claim 14 further including evaluating at least one of the network information and the media player information and, based upon the evaluation, determining to change one of:
a scheduled unicast transmission of a streamed media portion to a multicast transmission; and
a scheduled multicast transmission of a streamed media portion to a unicast transmission.

17. The method of claim 14 further includes determining to transmit streamed media to the media player through a plurality of multicast transmissions, each having at least one of a different set of media players or a different communication pathway.

18. The method of claim 16 further includes determining to transmit streamed media to the media player through the plurality of multicast transmissions as well as through a unicast transmission.

19. The method of claim 14 further including unicast transmitting streamed media to the media player until a unicast pointer for streamed media for the media player is pointing to an identification that is similar to a multicast pointer for the streamed media and then switching from unicast transmitting the streamed media to the media player to multicast transmitting the streamed media to the media player.

20. The method of claim 14 further including receiving a unicast transmission request message from the media player for unicast transmissions of the streamed media and switching from multicast transmitting a portion of the streamed media to unicast transmitting the portion of streamed media.

21. The method of claim 14 further including determining which of a plurality of networks and associated network communication protocols should be used to carry the streamed media portion and transmitting the streamed media portion accordingly.

22. The method of claim 14 wherein the scheduling occurs in response to receiving, within a specified period, a plurality of media request messages for streamed media for immediate delivery originated by each of the plurality of media players.

23. A method in a media player, comprising:
receiving streamed media multicast transmitted by a media server through a first pathway in a synchronized manner;
evaluating media player information; and
transmitting at least one of:
a unicast transmission request message to the media server to request that an unreceived portion of the streamed media be unicast transmitted based on the evaluation of the media player information; and
a status message containing the media player information to enable the media server to determine whether to unicast transmit at least a portion of the streamed media scheduled for multicast transmission.

24. The method of claim 23 wherein evaluating media player information includes evaluating media player playback status.

25. The method of claim 23 wherein evaluating media player information includes evaluating media player video reception status.

26. The method of claim 23 wherein evaluating media player information includes evaluating media player processing speed.

27. The method of claim 23 wherein evaluating media player information includes evaluating media player capacity.

28. The method of claim 23 wherein evaluating media player information includes evaluating at least one of:
an amount of unprocessed streamed media;
a media player unprocessed streamed media depletion rate;
a media player processing speed;
a streamed media reception rate;
a media player queue status that contains unprocessed streamed media;
a media player playback status;
a media player video reception status; and
a media player reception capacity.

29. A method for synchronizing content transmission, comprising:
communicating with a first intermediary node to prompt the first intermediary node to synchronize unicast transmitted frames for transmission as a multicast frame; and
transmitting control commands to the first intermediary node to command the first intermediary node to delay or buffer at least one received unicast frame to support transmission of a multicast frame.

30. The method of claim 29 further including communicating with the intermediary node to specify a destination of the multicast frame.

31. The method of claim 30 further including communicating with a second intermediary frame to prompt the second intermediary frame to transmit a received multicast frame as a unicast frame to a specified destination.
